(19) United States
(12) Patent Application Publication
(10) Pub. No.: US 2006/0098549 A1
(43) Pub. Date: May 11, 2006

(54) Optical disk apparatus and optical disk evaluation method

(76) Inventors: Hidemitsu Senoo, Osaka (JP); Koji Hayashi, Gifu (JP)

Correspondence Address: FISH & RICHARDSON P.C., P.O. BOX 1022, MINNEAPOLIS, MN, 55440-1022, US

(21) Appl. No.: 11/268,775

(22) Filed: Nov. 8, 2005

(30) Foreign Application Priority Data
Nov. 9, 2004 (JP) 2004-325002

(51) Int. Cl. G11B 5/09

(52) U.S. Cl. 369/59.12

(57) ABSTRACT

An optical disk apparatus irradiating a laser beam to an optical disk and receiving reflected light of the laser beam changed by marks recorded on the optical disk to perform evaluation of the optical disk based on a regeneration signal corresponding to an amount of light of the reflected light, the apparatus comprising a measurement circuit, based on a relationship that phases substantially match between a first timing of each of a rising edge and falling edge in a binarized signal of the regeneration signal and a second timing of a rising edge or falling edge in a synchronized clock signal conforming in phase to the binarized signal, measuring a phase difference between the first timing and a third timing of the synchronized clock signal shifted by a predetermined phase of the synchronized clock signal from the second timing as a reference.

### CROSS-REFERENCE TO RELATED APPLICATIONS

The present application claims priority from Japanese Patent Application No. 2004-325002 filed on Nov. 9, 2004, which is herein incorporated by reference.

### BACKGROUND OF THE INVENTION

1. Field of the Invention

The present invention relates to an optical disk apparatus and an optical disk evaluation method.

2. Description of the Related Art

Conventionally, an evaluation apparatus called “jitter meter” has been used as an evaluation apparatus for an optical disk. See, e.g., Japanese Patent Application Laid-Open Publication No. H11-167720. Such an evaluation apparatus quantitatively measures a degree of blur of regeneration signals obtained from an optical disk, called “jitter”. However, a dedicated jitter meter is expensive and evaluation of the jitter cannot perform easily. Therefore, a method is proposed for evaluating the jitter through the use of an apparatus recording and/or regenerating information to and/or from an optical disk (hereinafter, referred to as an “optical disk apparatus”)

FIG. 10 is a diagram showing a CD recording/regenerating apparatus 100 with a jitter evaluation function.

First, Description will be made of normal regeneration operation of an optical disk 11 in the CD recording/regenerating apparatus 100.

An optical pickup 10 receives reflected light of a laser beam irradiated to the optical disk 11 and picks up intensities of the reflected light as changes in voltage values. A servo circuit 12 controls a read position of the optical pickup 10 relative to the optical disk 11 such that the optical pickup 10 can read data corresponding to marks or spaces recorded on the optical disk 11, in the correct order.

The marks are portions where the reflected light of the laser beam is weakened and the spaces are portions where the reflected light of the laser beam is strengthened. In other words, the marks and the spaces are identified by the reflected light of the laser beam changed by concavity and convexity of a reflection layer or phase changes on a recording layer of the optical disk 11.

A binarization circuit 13 reads changes in voltage values output from the optical pickup 10 and generates EFM signals defining 588 bits as one (1) frame. The EFM signal is made up of repetition of H levels and L levels. For H sections indicating H levels from the rising edge to the falling edge of the EFM signal or L sections indicating L levels from the falling edge to the rising edge of the EFM signal, nine (9) types exist in the range between 3T and 11T. “1T” is one-bit interval and defined as about 230 ns. Hereinafter, the H/L sections are referred to as “EFM edge intervals”.

A digital signal processing circuit 14 performs EFM demodulation for the EFM signals supplied from the binarization circuit 13. Further, CIRC decoding is performed for the EFM-modulated signals to generate CD-ROM data which have 24 bytes per frame. A CD-ROM decoder 15 performs error detection processing and error correction processing for the CD-ROM data supplied from the digital signal processing circuit 14 and outputs to a host computer (not shown) the CD-ROM data processed with such processing.

A buffer RAM 16 is connected to the CD-ROM decoder 15 and temporarily stores the CD-ROM data supplied from the digital signal processing circuit 14 to the CD-ROM decoder 15, in units of one (1) block. Since a large amount of data must be stored in this way, typically, a DRAM is employed as the buffer RAM 16.

A microcomputer 17 is constructed with so-called one-chip microcomputer incorporating a ROM and RAM and controls the operation of the CD-ROM decoder 15 in accordance with a control program stored in the ROM. At the same time, the microcomputer 17 stores command data supplied from the host computer or sub-code data supplied from the digital signal processing circuit 14 into the built-in RAM once. In this way, the microcomputer 17 controls the operation of each unit in response to instructions from the host computer and allows the CD-ROM decoder 15 to output desired CD-ROM data to the host computer.

Then, Description will be made of a jitter evaluation method in the CD recording/regenerating apparatus 100.

The optical pickup 10, optical disk 11, servo circuit 12 and binarization circuit 13 performs the same operation as the regeneration operation of the optical disk 11 due to the microcomputer 17. However, the operations of the digital signal processing circuit 14 and CD-ROM decoder 15 are stopped by the microcomputer 17 and the buffer RAM 16 operates differently from the regeneration operation.

A counter 18 is connected to the binarization circuit 13 and captures the EFM signal supplied from the binarization circuit 13. The counter 18 sequentially counts each EFM edge interval of the EFM signal and serially writes each count value to the buffer RAM 16. In single-speed operation of the CLV operation with a constant linear velocity, 1T of the EFM signal is about 230 ns. Therefore, the counter 18 performs the count operation using, for example, 2 ns per cycle, i.e., 500 MHz counter. In this case, ideal values of the count value are “345” when the EFM edge interval is “3T (about 690 ns)”, “460” when the EFM edge interval is “4T”, . . . , and “1265” when the EFM edge interval is “11T”.

After such a series of processings are performed for data in a given region recorded on the optical disk 11, the microcomputer 17 analyzes each count value recorded on the buffer RAM 16 to perform the evaluation of the jitter.

Recently, due to diversification of an optical disk medium, speedup of an optical-disk recording/regenerating speed and the like, recording control of an optical disk is increasingly complicated. Also, since mark lengths are shortened and track intervals are narrowed due to densification of the optical-disk recording, inter-symbol interference between data and cross talk between tracks are generated, making correct recording/regeneration of an optical disk difficult. Therefore, in order to correctly comprehend a recording/regeneration quality of an optical disk to take countermeasures such as a write strategy, the jitter evaluation is becoming increasingly important.

By the way, in a conventional optical disk apparatus with the jitter evaluation function such as the CD recording/regenerating apparatus 100, the jitter is evaluated by analyzing measurement results of the EFM edge intervals corresponding to the optical disk standards 3T to 1T. Therefore, since a conventional optical disk apparatus analyzes only the measurement results of the EFM edge intervals, it is difficult to correctly comprehend factors generating the jitter and characteristics thereof, and a conventional optical disk apparatus has limitations to implement a more detail analysis for the jitter evaluation.

### SUMMARY OF THE INVENTION

In order to solve the above problems, an aspect of the present invention provides an optical disk apparatus irradiating a laser beam to an optical disk and receiving reflected light of the laser beam changed by marks recorded on the optical disk to perform evaluation of the optical disk based on a regeneration signal corresponding to an amount of light of the reflected light, the apparatus comprising a measurement circuit, based on a relationship that phases substantially match between a first timing of each of a rising edge and falling edge in a binarized signal of the regeneration signal and a second timing of a rising edge or falling edge in a synchronized clock signal conforming in phase to the binarized signal, measuring a phase difference between the first timing and a third timing of the synchronized clock signal shifted by a predetermined phase of the synchronized clock signal from the second timing as a reference.

According to the present invention, an optical disk apparatus and an optical disk evaluation method thereof can be provided for enabling a more detail analysis of jitter evaluation.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a diagram showing an overall configuration of an optical disk apparatus according to an implementation of the present invention;

FIG. 2 is a diagram showing a reference frequency of a synchronized clock signal for each medium, according to the implementation of the present invention;

FIG. 3 is a diagram for describing a phase relationship between an EFM signal and the synchronized clock signal, according to the implementation of the present invention;

FIG. 4 is a diagram showing a data content written into a memory according to the implementation of the present invention;

FIG. 5 is a diagram showing a configuration of a measurement circuit according to the implementation of the present invention;

FIG. 6 is a diagram showing a configuration of the measurement circuit according to another implementation of the present invention;

FIG. 7 is a diagram for describing operation of the measurement circuit according to another implementation of the present invention;

FIG. 8 is a diagram for describing operation of the measurement circuit according to another implementation of the present invention;

FIG. 9 is a diagram showing an overall configuration of an optical disk apparatus in the case of sharing the measurement circuit according to another implementation of the present invention with a delay control circuit of a write strategy circuit; and

FIG. 10 is a diagram showing an overall configuration of a conventional optical disk apparatus.

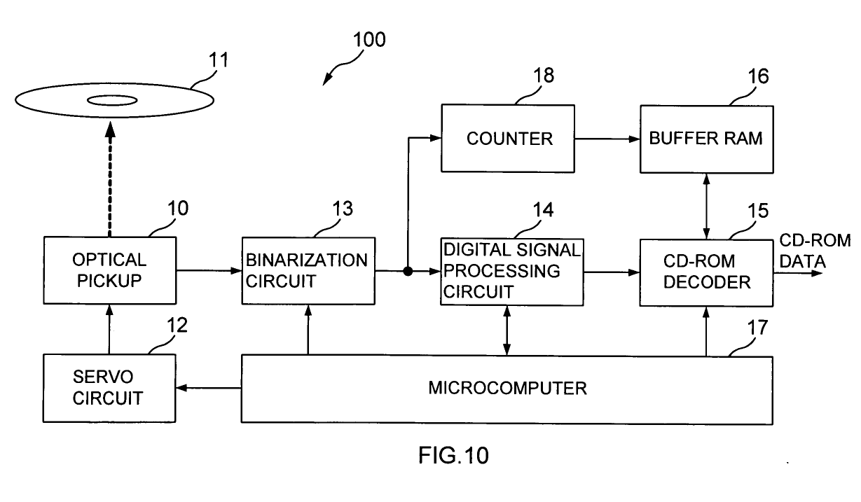

### DETAILED DESCRIPTION OF THE INVENTION

<Configuration/Operation of Optical Disk Apparatus>

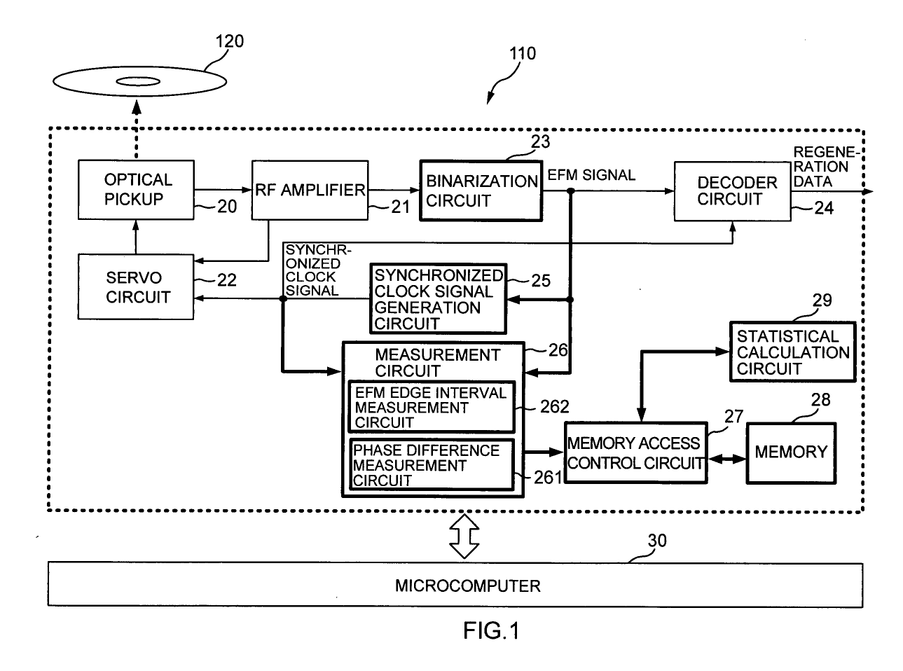

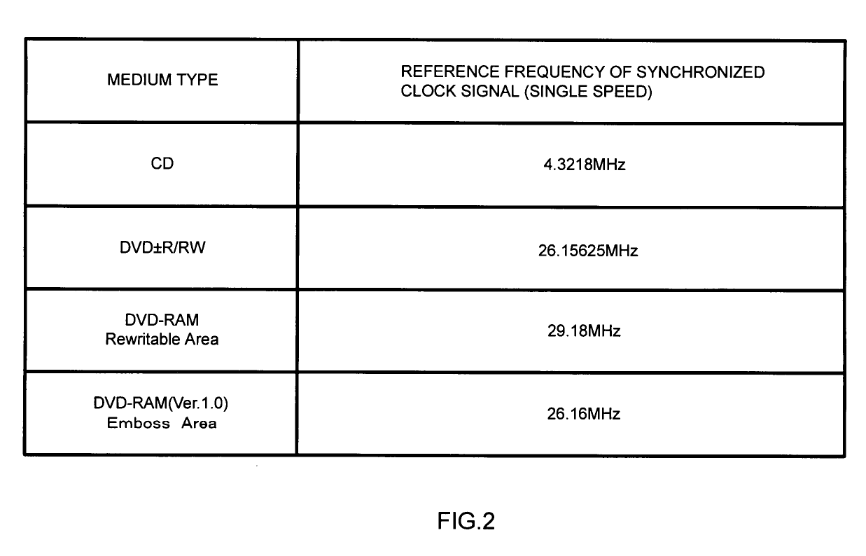

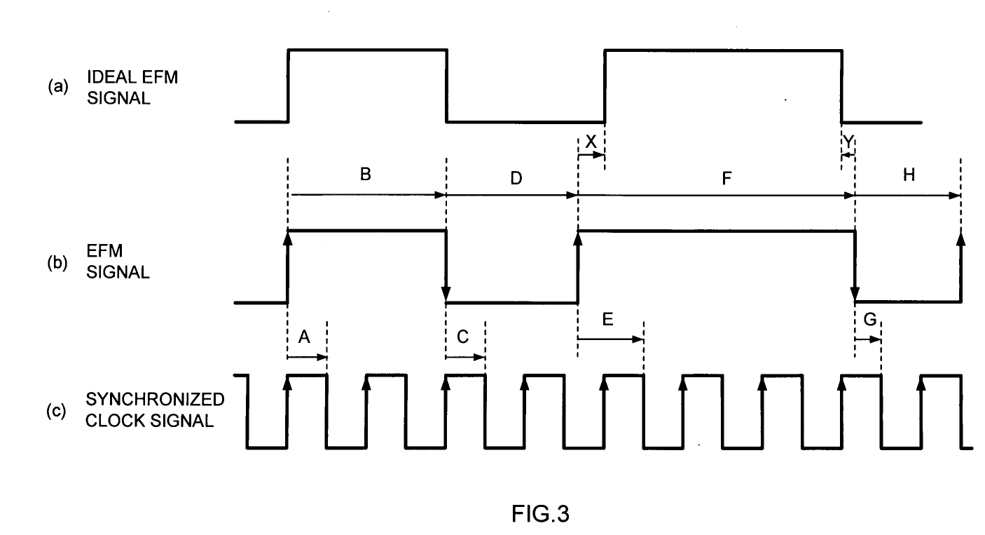

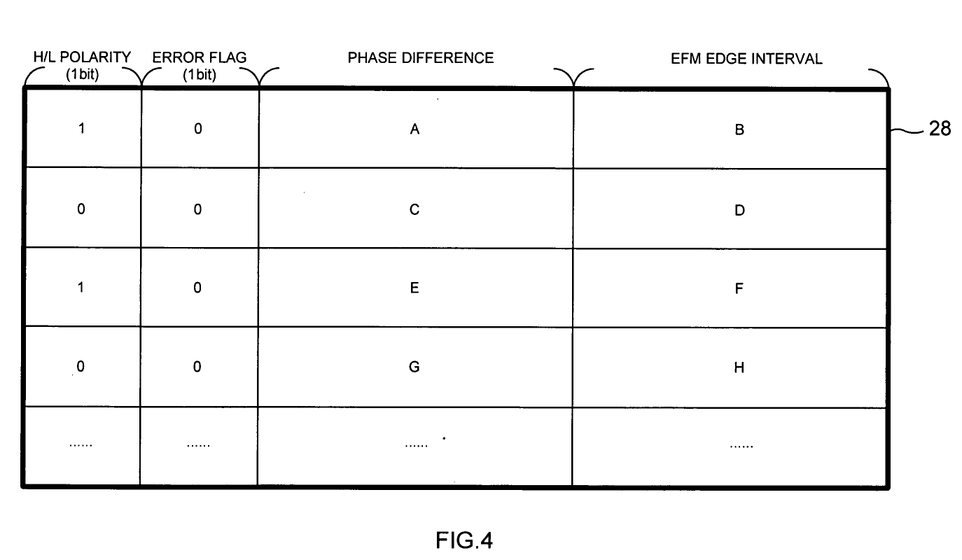

Configuration of Optical Disk Apparatus A configuration of an optical disk apparatus 110 according to one implementation of the present invention is described based on FIG. 1 with reference to FIG. 2, FIG. 3 and FIG. 4 accordingly. The optical disk apparatus 110 is an apparatus for regenerating information with radiation of a laser beam to an optical disk 120 such as a CD/DVD medium. Of course, the optical disk apparatus 110 may be an apparatus for also performing optical-disk recording.

Also, the optical disk apparatus 110 has a function for quantitatively evaluating a degree of blur of regeneration signals obtained from an optical disk 120, called “jitter”. By evaluating the jitter, the recording quality or regeneration quality of the optical disk 120 will be evaluated. As described in detail later, the jitter is quantitatively evaluated based on phase differences between EFM signals and synchronized clock signals, and EFM edge intervals.

An optical pickup 20 irradiates a laser beam to the optical disk 120 to regenerate information from the optical disk 120. The optical pickup 20 receives reflected light of the laser beam irradiated to the optical disk 120 and picks up intensities of the reflected light as changes in voltage values.

An RF amplifier 21 amplifies signals picked up from the optical disk 120 by the optical pickup 20 to the level which can be handled in subsequent processing to generate RF signals (“regeneration signals”). Also, the RF amplifier 21 often has the AGC (Automatic Gain Control) function for automatically adjusting an amplification factor thereof and a function for generating various servo control signals, such as tracking error signals and focus error signals.

A servo circuit 22 performs servo-control of various servo mechanisms provided in the optical pickup 20, based on the servo control signals generated by the RF amplifier 21. In this way, for example, position control of the optical pickup 10 is performed such that data corresponding to marks or spaces on the optical disk 120 can be read in the correct order.

A binarization circuit 23 is a circuit for receiving the supply of the RF signals generated by the RF amplifier 21 to binarize the RF signals and, for example, is constituted by a comparator comparing a RF signal level with a predetermined slice level. The binarized signals of the RF signals are supplied to a decoder circuit 24 and a synchronized clock signal generation circuit 25 in the case of a normal mode and are supplied to a measurement circuit 26 in the case of an optical disk evaluation mode.

The binarized signal of the RF signal is the EFM (8-14 modulation) signal in the case of a CD medium and is the EFM-Plus (8-16 modulation) signal in the case of a DVD medium. In the later description, the optical disk 120 is in the case of a CD medium and the binarized signal of the RF signal is in the case of the EFM signal.

The decoder circuit 24 performs EFM demodulation processing for the EFM signals supplied from the binarization circuit 23. Also, error detection processing in the CIRC scheme is performed for the EFM-demodulated signals. These decode-processed signals are output externally through an A/D converter not shown.

The synchronized clock signal generation circuit 25 generates synchronized clock signals (such as read channel clock signals and bit clock signals) synchronized to the marks and spaces of the EFM signals obtained from the optical disk 120. Specifically, the synchronized clock signal generation circuit 25 is constructed as a PLL circuit and the EFM signal supplied from the binarization circuit 23 is processed as a reference clock signal of the PLL circuit. Through phase matching operation of the PLL circuit, the synchronized clock signal phase-matched with the EFM signal is picked up as VCO output.

As shown in FIG. 2, synchronized clock signal reference frequencies (single speed) are standardized for each medium type of the optical disk 120. Also, for the synchronized clock signal, a following relationship is formed with an ideal EFM signal. The relationship is formed such that timing of each of a rising edge and falling edge in the ideal EFM signal (hereinafter referred as “first timing”) is completely matched with timing of either a rising edge or falling edge in the synchronized clock signal (hereinafter referred as “second timing”). In the description below, the second timing of the synchronized clock signal is in the case of the timing of the rising edge in the synchronized clock signal.

However, between the synchronized clock signal and the EFM signal obtained as a result of regeneration of recorded data actually recorded, the phases of the first timing and the second timing are only approximately matched, rather than completely matched, and phase differences are slightly fluctuated between the first and second timing.

The measurement circuit 26 has a phase difference measurement circuit 261 and an EFM edge interval measurement circuit 262.

Based on the relationship approximately matching the phases of the first timing of the regenerated EFM signal and the second timing of the synchronized clock signal, the phase difference measurement circuit 261 measures a phase difference of timing of a rising edge or falling edge of a predetermined synchronized clock signal with a shifted phase (hereinafter, referred to as “third timing”), using the first timing of the EFM signal and the second timing as references. In the implementation, the third timing is defined as the rising edge of the synchronized clock signal shifted by a half-cycle.

The EFM edge interval measurement circuit 262 measures an H section indicating an H level from the rising edge to the falling edge of the EFM signal or an L section indicating an L level from the falling edge to the rising edge of the EFM signal.

The measurement circuit 26 performs the phase difference measurement as well as the EFM edge interval measurement as shown in FIGS. 3A to C, for example. FIG. 3A is a waveform of the ideal EFM signal; FIG. 3B is a waveform of the regenerated EFM signal actually obtained from the optical disk 120; and FIG. 3C is a waveform of the synchronized clock signal generated based on the EFM signal actually obtained.

The phase difference measurement circuit 261 measures phase differences (“A” and “E” shown in FIGS. 3A to C) between the first timing of the rising edges of the EFM signal (FIG. 3B) and the third timing of the immediately subsequent falling edges of the synchronized clock signal (FIG. 3C) as well as measures phase differences (“C” and “G” shown in FIGS. 3A to C) between the first timing of the falling edges of the EFM signal (FIG. 3B) and the third timing of the immediately subsequent falling edges of the synchronized clock signal (FIG. 3C).

The EFM edge interval measurement circuit 262 measures the H sections (“B” and “F” shown in FIGS. 3A to C) from the rising edges to the falling edges of the EFM signal (FIG. 3B) as well as measures the L sections (“D” and “H” shown in FIGS. 3A to C) from the falling edges to the rising edges of the EFM signal (FIG. 3B).

A memory access control circuit 27 controls access (read/write) to a memory 28. The memory 28 is a storage device such as DRAM or SDRAM which can be accessed by a microcomputer 30. For example, the memory access control circuit 27 performs control for writing to predetermined storage areas of the memory 28 the phase differences (A, C, E, G) and EFM edge intervals (B, D, F, H) measured by the measurement circuit 26, H/L polarities representing either the H section or the L section, error flags indicating that data has not written correctly into the memory 28, and the like. FIG. 4 shows an example of the measurement result of the measurement circuit 26 written into the memory 28.

A statistical calculation circuit 29 reads the EFM edge intervals and the like stored in the memory 28 through the memory access control circuit 27 and writes results after various statistical calculations into predetermined storage areas of the memory 28 again. For example, statistical computation circuit 29 calculates an appearance frequency of each EFM edge interval (3T to 11T) of the EFM signal.

The microcomputer 30 is a processor responsible for overall control of the optical disk apparatus 110. Especially, the microcomputer 30 makes a histogram of the appearance frequency of each EFM edge interval (3T to 11T) of the EFM signal written into the memory 28 by the statistical calculation circuit 29 to quantitatively evaluate the jitter. The jitter evaluation is not limited to histograms and may be performed using other statistical amounts such as average amounts or distribution amounts.

Also, the microcomputer 30 decides whether or not the phase difference measured by the measurement circuit 26 is a predetermined value corresponding to the optical disk 120 (e.g., in the case of a CD medium, a phase difference corresponding to (1/4.3218 MHz)/2). For example, in the example shown in FIG. 3, it is decided that the phase differences A and C are the ideal values, that the phase difference E is larger than the ideal value and that the phase difference G is smaller than the ideal value.

Based on the decided result, the microcomputer 30 can identify, for example, whether offsets from ideal positions are generated on the leading end side or the back end side of the marks, and degrees of the offsets. In other words, as is the case with the EFM edge intervals, the microcomputer 30 quantitatively evaluates the jitter with the use of new evaluation criterion which is the phase difference between the EFM signal and the synchronized clock signal.

Also, after performing the evaluation described above in a test-write area of the optical disk 120, the microcomputer 30 performs following adjustment in order to make the EFM signal to be recorded on the storage area of the optical disk 120 closer to the ideal EFM signal (FIG. 3a). With the write strategy or the like, the microcomputer 30 can perform adjustment such that the first timing of the rising edge of the EFM signal at the time of the measurement of the phase difference E is shifted backward by X shown in FIGS. 3A to C and such that the first timing of the falling edge of the EFM signal at the time of the measurement of the phase difference G is shifted backward by Y shown in FIGS. 3A to C.

In this way, the optical disk apparatus 110 can quantitatively analyze the jitter in detail.

<Measurement by Counter>

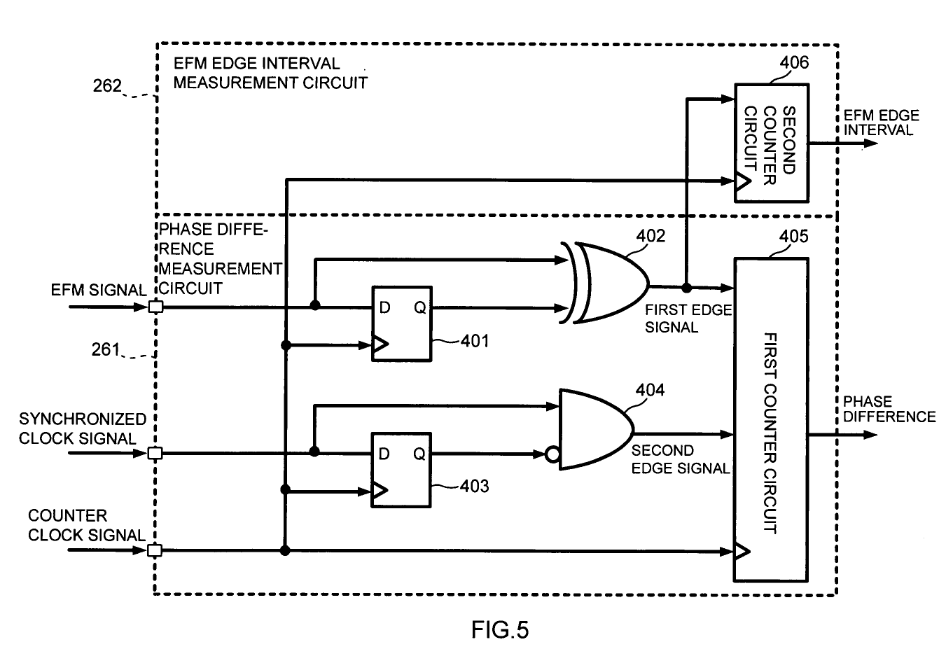

FIG. 5 is a diagram showing one implementation of the measurement circuit 26.

The phase difference measurement circuit 261 is constituted by flip-flop circuits 401, 403, an EXOR element 402, an AND element with two (2) inputs one of which is reversed, and a first counter circuit 405.

A circuit constituted by the flip-flop circuits 401 and the EXOR element 402 (a “first edge signal generation circuit”) detects the first timing of the EFM signal and generates a signal indicating that detection (hereinafter, referred to as a “first edge signal”).

A circuit constituted by the flip-flop circuits 403 and the AND element 404 (a “second edge signal generation circuit”) detects the third timing of the synchronized clock signal and generates a signal indicating that detection (hereinafter, referred to as a “second edge signal”).

The first counter circuit 405 is triggered by the supply of the first edge signal from the ExOR element 402 to count the phase difference corresponding to a period until next time the second edge signal is supplied from the AND element 404, based on a predetermined counter clock signal.

The EFM edge interval measurement circuit 262 is constituted by a second counter circuit 406 and, based on the first edge signal supplied from the EXOR element 402, counts the EFM edge interval, based on a predetermined counter clock signal.

The first counter circuit 405 may be constructed to be triggered by the second edge signal to capture a count value of the second counter circuit 402, instead of performing the counter operation.

<Measurement by Delay Circuit>

Configuration of Measurement Circuit

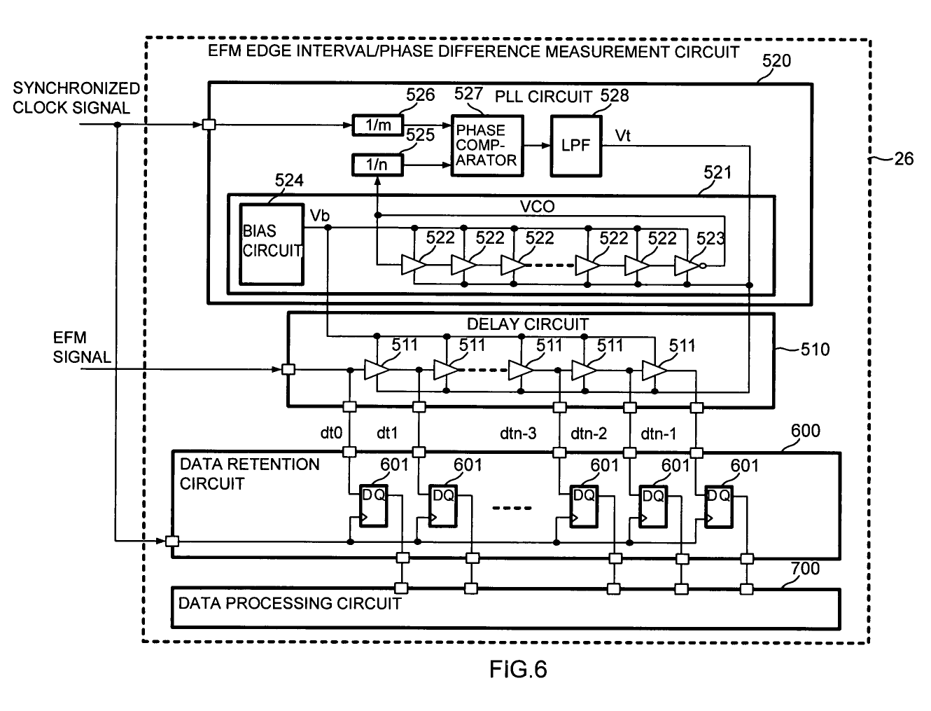

FIG. 6 shows a diagram showing another implementation of the measurement circuit 26.

A delay circuit 510 is constructed by serially connecting a plurality of first delay elements 511 and sequentially delays the EFM signal supplied from the input side toward the output side. In the delay circuit 510, a delay amount is set as predetermined cycles (e.g., one (1) cycle) of the synchronized clock signal. Also, a delay amount dt of the first delay elements 511 is set to “predetermined cycles of the synchronized clock signal/the stage number S of the first delay elements 511”.

For example, if the predetermined cycles of the synchronized clock signal is one (1) cycle (1T) and if the stage number S of the first delay elements 511 constituting the delay circuit 510 is 16 stages, the delay amount dt of one of the first delay elements 511 is set to “1T/16”. In this case, when the EFM signal is propagated on the delay circuit 510 for a period which is a reference cycle 1T of the EFM signal, each first delay element 511 buffers level data (H or L) of the signal delayed each time by “T/16” in the order from the input side to the output side.

A PLL circuit 520 is provided in order to constrain variations of each delay amount of the first delay elements 511 due to fabrication variations, temperature changes and the like. If a predetermined accuracy can be obtained for the delay amount of the delay circuit 510, the PLL circuit 520 is not needed to be provided.

The PLL circuit 520 has a VCO 521, a first divider circuit 525, a second divider circuit 526, a phase comparator 527 and a LPF 528.

In the VCO 521, a plurality of second delay elements 522 corresponding to each of the first delay element 511 of the delay circuit 510 is connected in a ring form.

A bias voltage Vb generated in a bias circuit 524 is supplied to one of power terminals of each second delay element 522 and the other power terminal of each second delay element 522 is constructed to be supplied with a control voltage Vt from the LPF 528. In other words, in the VOC 521, the delay amount of each second delay element 522 is controlled based on the control voltage Vt.

The first divider circuit 525 divides the output signal of the VOC 521 into “1/n”. The second divider circuit 526 divides a reference clock signal supplied from outside of the PLL circuit 520 into “1/m”.

The phase comparator 527 performs phase-comparison between a dividing signal of the first divider circuit 525 and a dividing signal of the second divider circuit 526.

The LPF 528 generates the control voltage Vt corresponding to the output signal of the phase comparator 527.

At this point, it is assumed that the PLL circuit 520 enters into a so-called lock state. If a frequency of the reference clock signal is f0, a relationship is formed as (equation 1): “dt=(m/n)·(½s·f0)”.

The first delay elements 511 constituting the delay circuit 510 are constructed identically to the second delay elements 522 constituting the VCO 521 and are supplied with the bias voltage Vb and control voltage Vt as is the case with the second delay elements 522. Therefore, the delay amount of the first delay elements 511 of the delay circuit 510 become identical to the delay amount dt of the second delay elements 522 of the VCO 521 and become a constant value dependent on the frequency f0 of the reference clock signal in the case of the lock state.

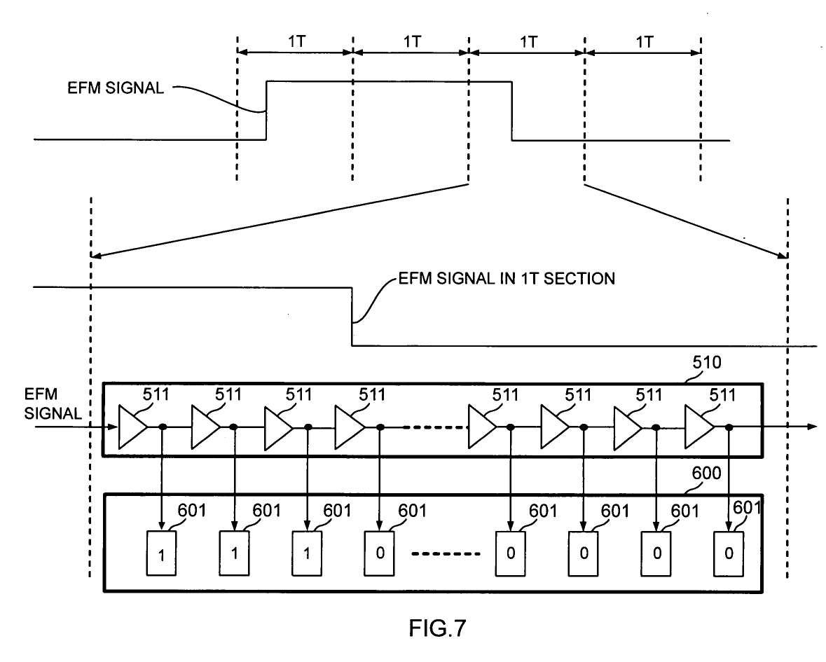

A data retention circuit 600 collectively retains a plurality of level data of the EFM signal obtained from each of the first delay elements 511 in the delay circuit 510, as shown in FIG. 7. Specifically, if the propagation period of the EFM signal on the delay circuit 510 is one (1) cycle of the synchronized clock signal, i.e., the reference cycle 1T of the EFM signal, each first delay element 511 constituting the delay circuit 510 buffers level data (H or L) of the signal sequentially delayed in the order from the input side to the output side of the delay circuit 510. Therefore, each time the reference cycle 1T of the EFM signal elapses, a plurality of the flip-flop circuits 601 of the data retention circuit 600 collectively retains a plurality of the level data corresponding to the reference cycle 1T of the EFM signal obtained from a delay line 510.

At this point, synchronization is achieved between the cycle period for collectively retaining a plurality of level data of the EFM signal in the data retention circuit 600 and the cycle period for propagating the EFM signal through all the first delay elements 511 in the delay circuit 510. This is caused by using the common synchronized clock signal for the delay amount control in the PLL circuit and the data retention processing in the data retention circuit 600.

A data processing circuit 700 converts a plurality of level data retained collectively in the data retention circuit 600 into a data format which is easily analyzed by the microcomputer 30.

For example, the data processing circuit 700 identifies the EFM edge interval and the phase difference and generates predetermined data as follows.

First, it is not known which 1T period of the EFM signal corresponds to a level data group to which a plurality of level data retained in the data retention circuit 600 belongs. Therefore, the data processing circuit 700 analyzes level data group corresponding to at least 1T or more periods from the data retention circuit 600 to identify the polarity-inversion timing (first timing) from H to L or L to H in the level data group. Then, based on the identified polarity-inversion timing, the data processing circuit 700 generates data for the actual measurement length of the EFM edge interval and H/L polarity data indicating whether the EFM edge interval data has the H or L polarity.

Also, the data processing circuit 700 detects the first timing of the EFM signal based on a plurality of the level data retained collectively as well as identifies a phase difference as a dereference between the detected first timing and the third timing in a predetermined cycle of the synchronized clock signal corresponding to a plurality of the level data retained collectively. Then, the data processing circuit 700 generates data for the identified phase difference, polarity data of the edge (the rising edge or falling edge) of the EFM signal when the phase difference is identified, and the like.

The processing of the data processing circuit 700 may be implemented by the microcomputer 30.

Specific Example of Operation of Optical Disk Apparatus

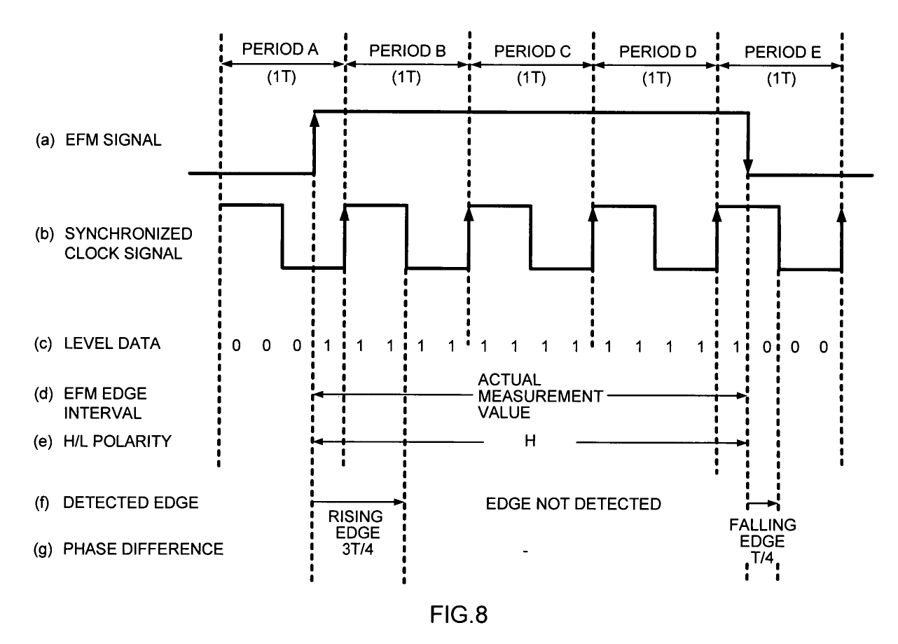

Description will be made of an implementation in the case of utilizing a plurality of level data retained collectively in the data retention circuit 600 for the jitter evaluation, based on FIG. 8. The figure shows the case that the stage number S of the first delay elements 511 is 4 and that the data retention circuit 600 is provided with four (4) flip-flop circuits 601.

In an example shown in the figure, an observation can be made for the EFM signal corresponding to 3T of H-level periods from a level data group retained collectively in the data retention circuit 600 for a total of 5T periods from a period A to a period E.

Then, the data processing circuit 700 analyzes the level data group retained collectively in the data retention circuit 600 between the period A and the period E. As a result, the polarity-inversion timing (first timing) from L to H of the EFM signal is identified by the level data “0001” corresponding to the period A. Also, it is identified that the level data are “1” from a period B to a period D consecutively. Further, the polarity-inversion timing (first timing) from H to L of the EFM signal is identified by the level data “1000” corresponding to the period E.

As a result, based on the polarity-inversion timing identified from the period A and period E, the data processing circuit 700 generates EFM edge interval data indicating the actual measurement length of the EFM signal corresponding to 3T of H-level periods and H/L polarity data indicating that the EFM edge interval data are H.

Further, the data processing circuit 700 identifies a phase difference as a difference between the first timing in the period A and the third timing of the synchronized clock signal corresponding to the period A. In the example shown in FIG. 8, the identified phase difference is 3T/4.

Also, the data processing circuit 700 identifies a phase difference as a difference between the first timing in the period E and the third timing of the synchronized clock signal corresponding to the period E. In the example shown in FIG. 8, the identified phase difference is T/4.

In this way, in the measurement circuit, a plurality of level data retained collectively in the data retention circuit 600 is data obtained collectively from the delay circuit 510 and corresponds to respective sample data for each period corresponding to a delay amount of the delay circuit 51 (e.g., a reference cycle 1T of the EFM signal). When evaluating the jitter, in order to identify the EFM edge interval and the phase difference, the microcomputer 30 can refer to respective sample data for each period corresponding to a delay amount of the delay circuit 51 at one time.

Therefore, as compared to the case of using the first and second counters 405, 406 shown in FIG. 5, processing is not required for sequentially measuring the EFM edge intervals and the phase differences based on the counter clock signal. In other words, in the case of using the first and second counters 405, 406 shown in FIG. 5, the counter clock signal must have a higher frequency in order to obtain a higher measurement accuracy (resolution), however, in the case of the measurement circuit 26, such a constraint does not exist and a higher measurement accuracy (resolution) can be easily achieved.

Sharing with Write Strategy Circuit

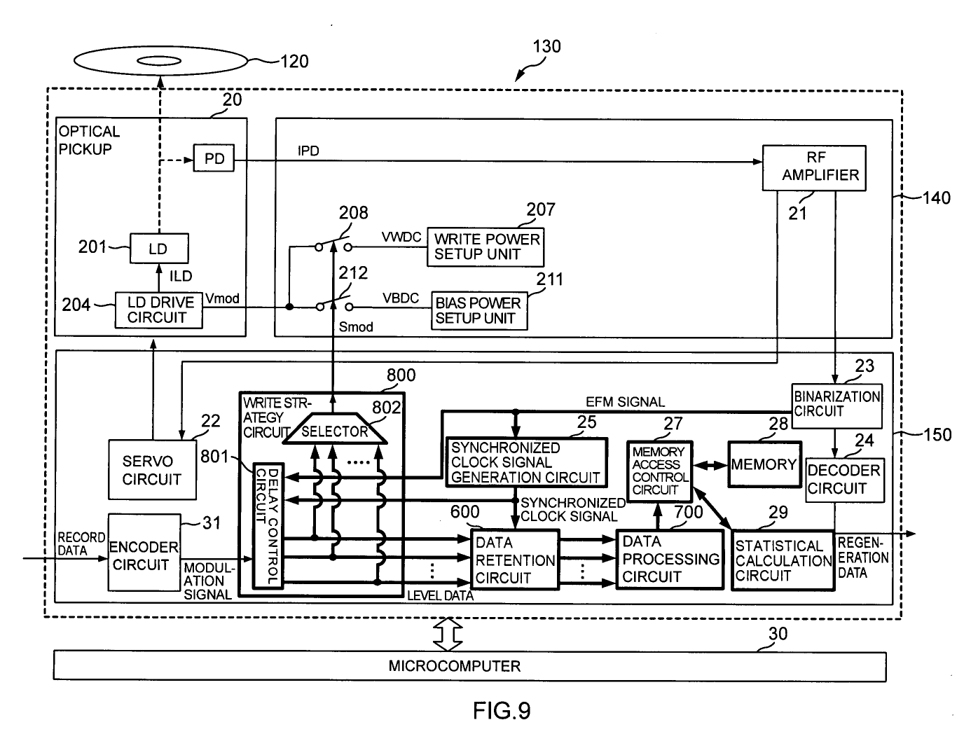

FIG. 9 is a diagram showing a configuration of an optical disk apparatus 130 according to another implementation of the present invention. For the same components as the optical disk apparatus 110 shown in FIG. 1, the same symbols are added and descriptions are omitted.

The optical disk apparatus 130 is constituted by the optical pickup 20, an analog signal processing circuit 140, a digital signal processing circuit 150 and the microcomputer 30 and irradiates a laser beam to the optical disk 120 to regenerate and record information.

The optical pickup 20 is comprised of a LD 201, a PD 203, LD drive circuit 204 and others, such as an objective lens and various servo mechanisms.

The LD 201 is a light emitting element which emits a laser beam for recording/regenerating to the optical disk 120, based on a drive current ILD supplied from the LD drive circuit 204. As a driving scheme (write strategy) of the LD 201, if the optical disk 120 is a recordable optical disk, a multi-pulse modulation scheme pattern is used. In other words, by generating one (1) record mark (record data) with record pulses which are a top pulse and multi-pulse, thermal distribution generated on the record marks are controlled. The record pulse is formed with a binary power level of write power Pw and bias power Pb.

The PD 203 is a light receiving element for receiving a portion of reflected light from the optical disk 120 to generate a received-light current IPD proportional to the amount of the received light. The received-light current IPD is converted to a voltage to be supplied to the RF amplifier. As a result, the RF amplifier generates RF signals and various servo control signals.

The LD drive circuit 204 generates the drive current ILD for driving the LD 201 based on a modulation signal Vmod generated by switching switches 208, 212 on/off.

The analog signal processing circuit 140 performs analog signal processing for driving the optical disk. For example, the analog signal processing circuit 140 has the RF amplifier for generating RF signals and various servo control signals as well as a write power setup unit 207 and a bias power setup unit 211.

The write power setup unit 207 generates a write power signal VWDC which is supplied to the LD drive circuit 204 if the switch 208 is turned on. The bias power setup unit 211 generates a bias power signal VBDC which is supplied to the LD drive circuit 204 if the switch 212 is turned on. Therefore, the LD drive circuit 204 drives the LD 201 based on the write power signal VWDC generated by the write power setup unit 207 and the bias power signal VBDC generated by the bias power setup unit 211.

The digital signal processing circuit 150 performs digital signal processing for controlling the optical disk, such as digital servo processing and encode/decode processing. In other words, the digital signal processing circuit 150 is provided with components in a dotted frame shown in FIG. 1, except the optical pickup 20 and the RF amplifier 21. The optical disk apparatus 130 further has an encoder circuit 31 and a write strategy circuit 800 in order to perform the optical-disk recording.

The encoder circuit 31 performs predetermined modulation processing depending on the specification of the optical disk 120 for the record data (such as image/audio/video data) to the optical disk 120 supplied from an external apparatus (such as a personal computer).

The write strategy circuit 800 generates a modulation switch signal Smod based on the modulation data which are the record data underwent the predetermined modulation processing of the encoder circuit 31 and supplies the modulation switch signal Smod to the switches 208, 212. As a result, the modulation signal Vmod supplied to the LD drive circuit 204, i.e., the record pulse for recording to the optical disk 120 is generated by switching the switches 208, 212 on/off based on the modulation switch signal Smod.

For the write strategy circuit 800, as a countermeasure to changes in the type of the optical disk 120 and in the recording state due to the rotation rate, it is proposed to providing a delay control circuit 801 and a selector 802 for sending the record pulse with delay to a laser mechanism, rather than directly sending to the laser mechanism the record pulse generated by the write strategy circuit 800. For example, this is disclosed in FIG. 2 of Japanese Patent Application Laid-Open Publication No. 1999-273252.

As is the case with FIG. 6, the delay control circuit 801 has a delay circuit with delay elements serially connected on a plurality of stages and a PLL circuit for controlling a delay amount of the delay circuit. The delay control circuit 801 sequentially delays the signal which is a generator of the record pulse, such as the EFM signal generated by the encoder circuit 31, with each delay element of the delay circuit, to which a delay amount is set by the PLL circuit.

The selector 802 selects the output of any one of the delay elements on each stage of the delay circuit in the delay control circuit 801 and picks up the output as a delay signal. Based on this delay signal, the modulation switch signal Smod and thus the record pulse are generated suitably for various recording states.

Therefore, in the optical disk apparatus 130, the delay circuit 510 shown in FIG. 6 is planned to be shared with the delay control circuit 801 of the write strategy circuit 800. In other words, the EFM signal generated by the binarization circuit 23 is supplied to the input side of the delay control circuit 801 to be sequentially delayed. On the other hand, the data retention circuit 600 collectively retains a plurality of level data of the EFM signal obtained from any one of the delay elements constituting the delay control circuit 801. As a result, the optical disk apparatus 130 does not have to be provided additionally with the delay circuit 500 shown in FIG. 6 and, in the digital signal processing circuit 150, the circuit scale and power consumption can be planed to be reduced because of this.

Although the implementations of the present invention have been set forth hereinabove, the above implementations are for the purpose of facilitating understanding of the present invention and are not intended to be construed as limiting the present invention. The present invention may be modified or altered without departing from the spirit thereof and encompasses equivalents thereof.

What is claimed is:

1. An optical disk apparatus irradiating a laser beam to an optical disk and receiving reflected light of the laser beam changed by marks recorded on the optical disk to perform evaluation of the optical disk based on a regeneration signal corresponding to an amount of light of the reflected light, the apparatus comprising:
a measurement circuit, based on a relationship that phases substantially match between a first timing of each of a rising edge and falling edge in a binarized signal of the regeneration signal and a second timing of a rising edge or falling edge in a synchronized clock signal conforming in phase to the binarized signal, measuring a phase difference between the first timing and a third timing of the synchronized clock signal shifted by a predetermined phase of the synchronized clock signal from the second timing as a reference.

2. The optical disk apparatus of claim 1, wherein the measurement circuit includes:
a first edge signal generator detecting the first timing and generating a first edge signal indicative of the detection;
a second edge signal generator detecting the third timing and generating a second edge signal indicative of the detection; and
a counter circuit, triggered by the supply of the first edge signal to count the phase difference corresponding to a period until next time the second edge signal is supplied, based on a predetermined counter clock signal.

3. The optical disk apparatus of claim 1, wherein the measurement circuit includes:
a delay circuit, constructed by serially connecting a plurality of first delay elements, to which is set a delay amount for predetermined cycles of the synchronized clock signal;
a plurality of flip-flop circuits, corresponding to each of a plurality of level data of the binarized signal obtained from the predetermined first delay element of the delay circuit; and
a data retention circuit, collectively retaining the plurality of level data of each of the plurality of flip-flop circuits each time the predetermined cycle is achieved by the synchronized clock signal.

4. The optical disk apparatus of claim 3, wherein the measurement circuit further includes a PLL circuit for controlling the delay amount of the delay circuit to a predetermined cycle of the synchronized clock signal.

5. The optical disk apparatus of claim 4, further comprising a write strategy circuit which generates a record pulse for recording to the optical disk, based on modulation data which are record data to the optical disk subjected to predetermined modulation processing, the write strategy circuit including a delay control circuit for controlling a delay amount of a signal which is a generator of the record pulse, wherein the delay circuit is shared with the delay control circuit disposed in the write strategy circuit.

6. An optical disk evaluation method of an optical disk apparatus, performed by irradiating a laser beam to an optical disk and receiving reflected light of the laser beam changed by marks recorded on the optical disk, based on a regeneration signal corresponding to an amount of light of the reflected light, the method comprising the steps of:
based on a relationship that phases substantially match between a first timing in a binarized signal of the regeneration signal and a second timing of a rising edge or falling edge in a synchronized clock signal conforming in phase to the binarized signal, measuring a phase difference between the first timing and a third timing of the synchronized clock signal shifted by a predetermined phase of the synchronized clock signal from the second timing as a reference; and
determining whether or not the measured phase difference is a predetermined value corresponding to the type of the optical disk.
